(19) United States
(12) Patent Application Publication
(10) Pub. No.: US 2024/0369859 A1
(43) Pub. Date: Nov. 7, 2024

(54) Laser-Level Glasses Device

(71) Applicant: Christopher Norris, Las Vegas, NV (US)

(72) Inventor: Christopher Norris, Las Vegas, NV (US)

(21) Appl. No.: 18/412,704

(22) Filed: Jan. 15, 2024

Related U.S. Application Data
(60) Provisional application No. 63/464,002, filed on May 4, 2023.

(51) Int. Cl. G02C 11/04; G01C 15/00; G01C 15/10; G02C 11/00

(52) U.S. Cl. CPC G02C 11/04; G01C 15/004; G01C 15/105; G02C 11/10

(57) ABSTRACT

A laser-level glasses device is provided. The device is comprised of a pair of glasses with an integrated auto-leveling laser. The laser projects one-axis or two-axis laser lines to produce vertical, horizontal, or perpendicular laser lines onto a surface.

### CROSS-REFERENCE TO RELATED APPLICATION

The present application claims priority to, and the benefit of, U.S. Provisional Application No. 63/464,002, which was filed on May 4, 2023, and is incorporated herein by reference in its entirety.

### FIELD OF THE INVENTION

The present invention relates generally to the field of leveling devices. More specifically, the present invention relates to a laser-level glasses device comprised of a pair of glasses with an integrated laser for projecting a laser line onto a surface. Accordingly, the present disclosure makes specific reference thereto. Nonetheless, it is to be appreciated that aspects of the present invention are also equally applicable to other like applications, devices, and methods of manufacture.

### BACKGROUND

Marking level lines is a common and crucial task in construction jobs to ensure proper alignment and balance in structures. A level line can be established using various tools such as a chalk line, which involves snapping a taut string coated in chalk to create a straight line on a surface. Alternatively, a laser-level can be employed for greater precision, projecting a straight laser line along a desired level. Another option is using a hand level, a more traditional approach requiring manual adjustment to find the horizontal plane.

However, each of these methods typically requires the use of at least one hand of the user. This can be a significant drawback in situations where the user needs both hands free for other tasks, such as holding or adjusting materials, operating additional tools, or maintaining balance and safety on a construction site.

Therefore, there exists a long-felt need in the art for an improved leveling device. There also exists a long-felt need for a laser-level glasses device that is wearable. More specifically, there exists a long-felt need for a laser-level glasses device that allows a user to create a level line in a hands-free manner.

The subject matter disclosed and claimed herein, in one embodiment thereof, comprises a laser-level glasses device. The device is comprised of a pair of glasses with an integrated auto-leveling laser. The laser projects one-axis or two-axis laser lines to produce vertical, horizontal, or perpendicular laser lines onto a surface.

In this manner, the laser-level glasses device of the present invention accomplishes all the foregoing objectives and provides an improved leveling device. More specifically, the device allows a user to create a level line in a hands-free manner via a wearable device.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a laser-level glasses device. The device is comprised of a pair of glasses comprised of a frame with at least one laser and at least one lens. The laser can project one-axis or two-axis laser lines to produce vertical, horizontal, or perpendicular laser lines.

The frame removably receives at least one lens. The lens is preferably made from a PPE-approved impact-resistant safety lens made from any material known in the art. In one embodiment, the lens is a prescription lens.

The frame is also comprised of at least one housing, wherein at least one laser is positioned within the housing. The laser may be any auto-leveling laser type and color known in the art. The laser can preferably project one-axis vertical and horizontal laser lines as well as perpendicular two-axis laser lines. The laser is powered by at least one battery.

The laser can be turned on/off via at least one button of the device. The button may also allow a user to cycle through the laser modes (i.e., vertical beam, horizontal beam, perpendicular beam). Further, the button may allow a user to change the brightness level of the laser line produced by the laser.

In one embodiment, the device is comprised of at least one speaker also powered by the battery. The speaker produces an audible tone when the beam from the laser is leveled to indicate said leveling to the user.

The present invention is also comprised of a method of using the device. First, a device is provided comprised of a frame with at least one laser, at least one battery, at least one button, and at least one lens. Then, the device can be placed on the head of a user and worn as a pair of glasses. Then, the laser can be turned on by the button. Next, the button can be pressed such that the laser produces a horizontal laser line, a vertical laser line, or a perpendicular laser line. Once the beam is produced and is automatically leveled, wherein the laser is auto-leveling, at least one speaker of the device produces an audible tone to alert the user that the laser line is level. Then, a user can use the laser line as a level reference point during construction or other tasks that require level lines.

Accordingly, the laser-level glasses device of the present invention is particularly advantageous as it provides an improved leveling device. More specifically, the device allows a user to create a level line in a hands-free manner via a wearable device. In this manner, the laser-level glasses device overcomes the limitations of existing leveling devices and methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a laser-level glasses device of the present invention in accordance with the disclosed architecture; and

FIG. 2 illustrates a flowchart of a method of using one potential embodiment of a laser-level glasses device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved leveling device. There also exists a long-felt need for a laser-level glasses device that is wearable. More specifically, there exists a long-felt need for a laser-level glasses device that allows a user to create a level line in a hands-free manner.

The present invention, in one exemplary embodiment, is comprised of a laser-level glasses device comprised of a pair of glasses comprised of a frame with at least one laser and at least one lens. The laser can project one-axis or two-axis laser lines to produce vertical, horizontal, or perpendicular laser lines.

The frame removably receives at least one lens preferably made from a PPE-approved impact-resistant safety lens made from any material known in the art. In one embodiment, the lens is a prescription lens. The frame is also comprised of at least one housing, wherein at least one laser is positioned within the housing. The laser may be any auto-leveling laser type and color known in the art. The laser can preferably project one-axis vertical and horizontal laser lines as well as perpendicular two-axis laser lines. The laser is powered by at least one battery.

The laser can be turned on/off via at least one button of the device. The button may also allow a user to cycle through the laser modes (i.e., vertical beam, horizontal beam, perpendicular beam). Further, the button may allow a user to change the brightness level of the laser line produced by the laser.

In one embodiment, the device is comprised of at least one speaker also powered by the battery. The speaker produces an audible tone when the beam from the laser is leveled to indicate said leveling to the user.

The present invention is also comprised of a method of using the device. First, a device is provided comprised of a frame with at least one laser, at least one battery, at least one button, and at least one lens. Then, the device can be placed on the head of a user and worn as a pair of glasses. Then, the laser can be turned on by the button. Next, the button can be pressed such that the laser produces a horizontal laser line, a vertical laser line, or a perpendicular laser line. Once the beam is produced and is automatically leveled, wherein the laser is auto-leveling, at least one speaker of the device produces an audible tone to alert the user that the laser line is level. Then, a user can use the laser line as a level reference point during construction or other tasks that require level lines.

Accordingly, the laser-level glasses device of the present invention is particularly advantageous as it provides an improved leveling device. More specifically, the device allows a user to create a level line in a hands-free manner via a wearable device. In this manner, the laser-level glasses device overcomes the limitations of existing leveling devices and methods known in the art.

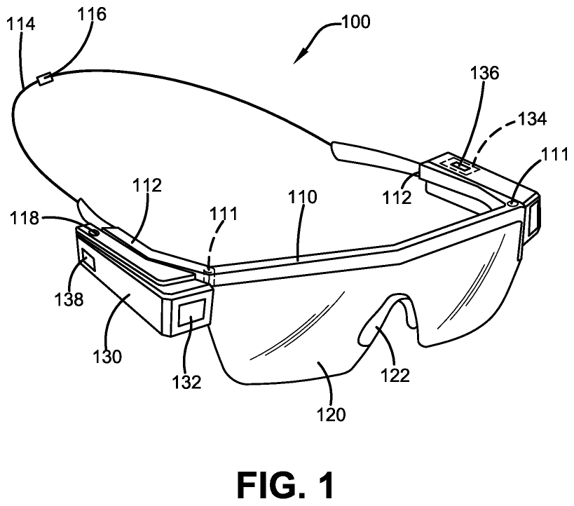

Referring initially to the drawings, FIG. 1 illustrates a perspective view of one potential embodiment of a laser-level glasses device 100 of the present invention in accordance with the disclosed architecture. The device 100 is comprised of a pair of glasses comprised of a frame 110 with at least one laser 132 and at least one lens 120. The laser 132 can project one-axis or two-axis laser lines to produce vertical, horizontal, or perpendicular laser lines.

The frame 110 may be comprised of any material such as, but not limited to, metal or plastic. The frame 110 is comprised of at least two frame arms 112 that may each fold via at least one hinge 111 of any hinge type known in the art. In one embodiment, the arms 112 are comprised of padded arms for comfort. In another embodiment, the arms 112 are flexible to better fit each user's head. In one embodiment, the arms 112 are connected by at least one safety cord 114 that secures the device 100 around the head of the user. In one embodiment, the cord 114 can be tightened or loosened by at least one fastener 116 such as, but not limited to, a buckle, a spring-lock, etc.

The frame 110 removably receives at least one lens 120. The lens 120 is preferably transparent but may be tinted any color. The lens 120 is preferably made from a PPE-approved impact-resistant safety lens made from any material known in the art. In one embodiment, the lens 120 is also a prescription lens. The lens 120 may be comprised of at least one nosepiece 122. The nosepiece 122 may be adjustable and padded for comfort. In one embodiment, the nosepiece 122 is attached to the frame 110 instead of the lens 120.

The frame 110 is also comprised of at least one housing 130, wherein at least one laser 132 is positioned within the housing 130. The housing 130 protects the laser 132 from impact damage. The laser 132 may be any auto-leveling laser type and color known in the art. The laser 132 can preferably project one-axis vertical and horizontal laser lines as well as perpendicular two-axis laser lines.

The laser 132 is powered by at least one battery 134. The battery 134 may be positioned within the housing 130 or elsewhere on the frame 110. The battery 134 may be removable or non-removable in different embodiments. The battery 134 may also be rechargeable or non-rechargeable in different embodiments. In a rechargeable embodiment, the device 100 is comprised of at least one charging port 136 that allows the battery 134 to be recharged. The charging port 136 is preferably, but not limited to, a USB port.

The laser 132 can be turned on/off via at least one button 138 of the device 100. The button 138 may also allow a user to cycle through the modes of the laser 132 (i.e., vertical beam, horizontal beam, perpendicular beam). Further, the button 138 may allow a user to change the brightness level of the laser line produced by the laser 132.

In one embodiment, the device 100 is comprised of at least one speaker 118 also powered by the battery 134. The speaker 118 produces an audible tone when the beam from the laser 132 is leveled to indicate said leveling to the user.

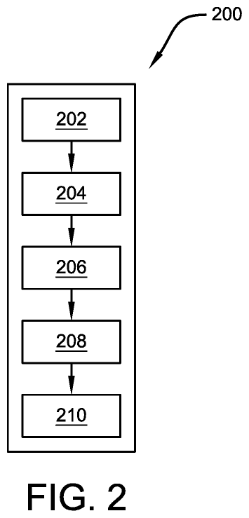

The present invention is also comprised of a method of using 200 the device 100, as seen in FIG. 2. First, a device 100 is provided comprised of a frame 110 with at least one laser 132, at least one battery 134, at least one button 138, and at least one lens 120 [Step 202]. Then, the device 100 can be placed on the head of a user and worn as a pair of glasses [Step 204]. Then, the laser 132 can be turned on by the button 138 [Step 206]. Next, the button 138 can be pressed such that the laser 132 produces a horizontal laser line, a vertical laser line, or a perpendicular laser line [Step 208]. Once the beam is produced and is automatically leveled, wherein the laser 132 is an auto-leveling laser, at least one speaker 118 of the device produces an audible tone to alert the user that the laser line is level. Then, a user can use the laser line as a level reference point during construction or other tasks that require level lines [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “laser-level glasses device” and “device” are interchangeable and refer to the laser-level glasses device 100 of the present invention.

Notwithstanding the foregoing, the laser-level glasses device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the laser-level glasses device 100 as shown in the FIGS. are for illustrative purposes only, and that many other sizes and shapes of the laser-level glasses device 100 are well within the scope of the present disclosure. Although the dimensions of the laser-level glasses device 100 are important design parameters for user convenience, the laser-level glasses device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A laser-level glasses device comprising:
a glasses frame;
a lens;
a housing comprised of a laser; and
a battery positioned in the housing.

2. The laser-level glasses device of claim 1, wherein the laser produces a one-axis laser line or a two-axis laser line.

3. The laser-level glasses device of claim 2, wherein the laser produces a vertical laser line, a horizontal laser line, or a perpendicular laser line.

4. The laser-level glasses device of claim 1, wherein the glasses frame is comprised of a frame arm.

5. The laser-level glasses device of claim 1 further comprised of a safety cord.

6. The laser-level glasses device of claim 1, wherein the lens is comprised of an impact-resistant lens.

7. The laser-level glasses device of claim 1, wherein the lens is comprised of a prescription lens.

8. The laser-level glasses device of claim 1 further comprised of a nosepiece.

9. The laser-level glasses device of claim 1, wherein the battery is removable from the housing.

10. A laser-level glasses device comprising:
a glasses frame;
a lens;
a housing comprised of an auto-leveling laser; and
a battery comprised of a charging port, the battery positioned in the housing.

11. The laser-level glasses device of claim 10, wherein the auto-leveling laser produces a one-axis laser line or a two-axis laser line.

12. The laser-level glasses device of claim 11, wherein the auto-leveling laser produces a vertical laser line, a horizontal laser line, or a perpendicular laser line.

13. The laser-level glasses device of claim 10, wherein the glasses frame is comprised of a frame arm.

14. The laser-level glasses device of claim 10 further comprised of a safety cord.

15. The laser-level glasses device of claim 10, wherein the lens is comprised of an impact-resistant lens.

16. The laser-level glasses device of claim 10, wherein the lens is comprised of a prescription lens.

17. The laser-level glasses device of claim 10 further comprised of a nosepiece.

18. The laser-level glasses device of claim 10, wherein the battery is removable from the housing.

19. A method of using a laser-level glasses device, the method comprising the following steps:
providing a laser-level glasses device comprised of a frame comprised of a laser, a battery, a button, and a lens;
placing the laser-level glasses device on a head of a user;
turning on the laser via the button;
pressing the button such that the laser produces a laser line; and
using the laser line as a reference point.

20. The method of using a laser-level glasses device of claim 19, wherein the laser produces a vertical laser line, a horizontal laser line, or a perpendicular laser line.
